(19) United States
(12) Patent Application Publication
(10) Pub. No.: US 2022/0383768 A1
(43) Pub. Date: Dec. 1, 2022

(54) Electronic Flashcards for Reading Instruction

(71) Applicant: Beatrice Roseus, Rosedale, NY (US)

(72) Inventor: Beatrice Roseus, Rosedale, NY (US)

(21) Appl. No.: 17/331,542

(22) Filed: May 26, 2021

(51) Int. Cl. G09B 17/00; G09B 5/06

(52) U.S. Cl. CPC G09B 17/006; G09B 5/06

(57) ABSTRACT

An innovative electronic flashcard that can say, spell, sing, and record the word with a push of a button. Each electronic flashcard may have a series buttons to allow children to hear the word, spell the word with each letter lighting up, each flashcard may sing a kid-friendly song that goes with each of the sight words, and may allow students to record themselves saying, singing, and/or spelling the subject sight word. The letters displayed on the flashcards may also include a tactile aspect.

### CROSS-REFERENCES TO RELATED APPLICATIONS

Not Applicable.

### FIELD OF INVENTION

The present invention relates generally to a training device used in the instruction of reading skill to young students. More particularly, the present invention is related to an electronic flashcard device for teaching sight words.

### BACKGROUND OF THE INVENTION

In the beginning stages of primary education, students are instructed in reading through the introduction of letter sounds (phonemic awareness) and through the introduction of sight words. The term “sight words”, as used herein, refers to the words that are the most frequently used in the English language and which may have irregular spelling or otherwise lack phonetic spelling such that students must memorize or otherwise learn to recognize these words on sight, hence “sight words”. Examples of such sight words include, but are not limited to “I”, “me”, “like”, “the”, “see”, “you”, “your”, etc. There are over 100 sight words that young students are required to learn in the early stages of learning to read.

A traditional method of teaching students how to identify sight words is through the use of flashcards. Such flashcards traditionally include a single word on the face of the card. The instruction technique for a teacher, parent, or other adult to show the student the word and then read the word aloud. Instruction with flashcards requires repetition to ensure retention, which can require an overwhelming time commitment and can lead to frustrations for both the instructors and students when the words on the cards cannot be readily retained. Many times, no matter how many times the flashcards are used, the students cannot retain the information.

One cause for this problem with the traditional flashcard approach is that it does not accommodate all learning styles. Flashcards are geared mostly towards visual learners. As the term is used herein, “visual learners” refers to students who learn more effectively when they can see the information being presented in front of them. Other learning styles preferentially receive information through other modes, and thus are not best served by visual lessons like flashcards.

Another problem with the traditional flashcard approach is that the instructor, be it teach, parent, or other adult, must be present when using flashcards to ensure students are saying the correct word.

There exists a need to improve upon the traditional flashcard instruction technique in order to better accommodate students with diverse learning style as well as to reduce the time demand on instructors.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

The present invention is directed towards an innovative electronic flashcard that can say, spell, sing, and record the word with a push of a button. This product is to accommodate diverse learning styles with auditory, visual, and kinesthetic accommodations. Each electronic flashcard may have a series buttons to allow children to hear the word, spell the word with each letter lighting up. As the incorporation of songs is an important tool for teaching young students, the flashcards may sing a kid-friendly song that goes with each of the sight words, allowing for dance and movement to increase engagement in the lesson. The present invention may allow students to record themselves saying, singing, and/or spelling the subject sight word. The letters displayed on the flashcards may also include a tactile aspect. By incorporating multiple modes of communication for instruction, the present invention may accommodate many more students with diverse learning styles.

### BRIEF DESCRIPTION OF THE DRAWINGS

The present invention is described in detail below with reference to the attached drawing figures, wherein:

FIG. 1 illustrates a view of an exemplary electronic flashcard.

FIG. 2A illustrates a view of an exemplary electronic flashcard wherein a single letter of the subject sight word is lit.

FIG. 2B illustrates a view of an exemplary electronic flashcard wherein the subject sight word is lit.

FIG. 3 illustrates a computer system adapted according to certain embodiments of the present invention.

FIG. 4A is a block diagram illustrating a server hosting an emulated software environment.

FIG. 4B is a block diagram illustrating a server hosting an emulated hardware environment according to one embodiment of the disclosure.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

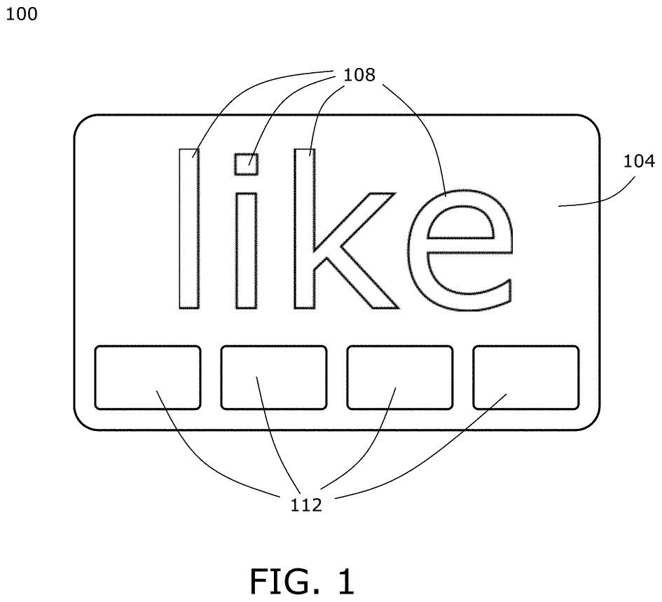

FIG. 1 provides a view of an exemplary electronic flashcard 100. As depicted, the electronic flash card 100 may include a display area 104. The display area 104 may comprise individually lit letters 108 spelling out the subject sight word. The electronic flashcard 104 may further include a series of buttons 112 such that pressing each button provides a different educational sensory experience. As used herein, the term “button” is used broadly to refer to a user input actuated by contact or gesture. One having skill in the art will recognize that input devices of this type may include, but are not limited to, resistive, capacitive, or optical touchscreens or regions thereof, flat panel membrane, dome-switch, scissor-switch, mechanical-switch, buckling-spring mechanism, Hall effect sensors, or the like.

Embodiments of the present invention may include a speaker or other audio output functionality enabled to reproduce sound, music and/or speech. Embodiments of the present invention may include a microphone or other audio input functionality as well as a read/write memory operable to store and reproduce audio data such as recordings of the student's voice.

Embodiments of the present invention may include a power source, such as a battery or the like. In some embodiments of the present invention, the power source may provide recharging functionality. One having skill in the art will recognize there are a variety of means for providing this recharging functionality, including, but not limited to, removable batteries or battery packs to be charged outside of the electronic flashcards, for instance, by docking with a charging station. Alternatively, the electronic flashcard may include a power cord adaptor to permit the power source to remain within the electronic flashcard be recharged via a power cord. One having skill in the art will recognize that many further recharging arrangements are possible.

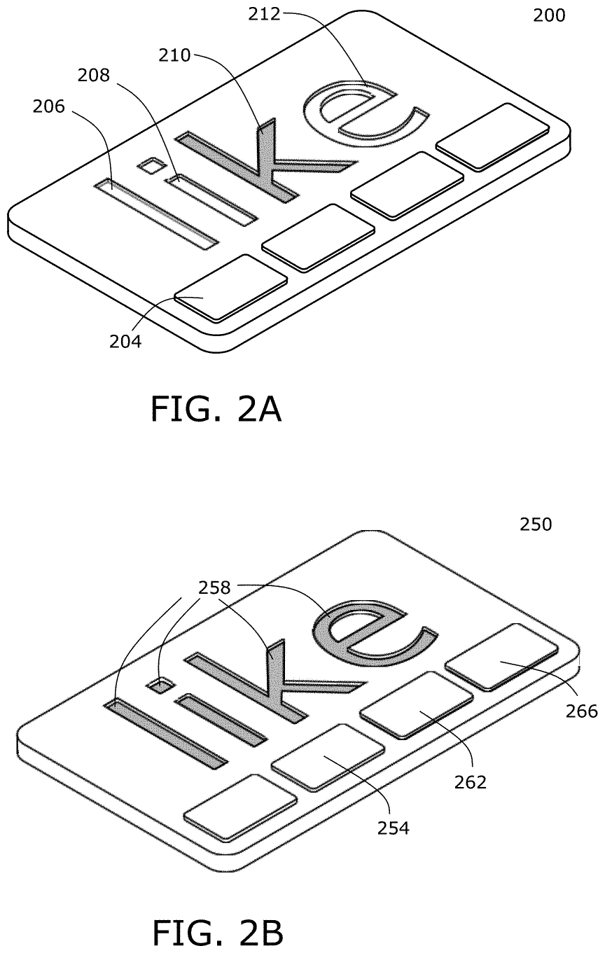

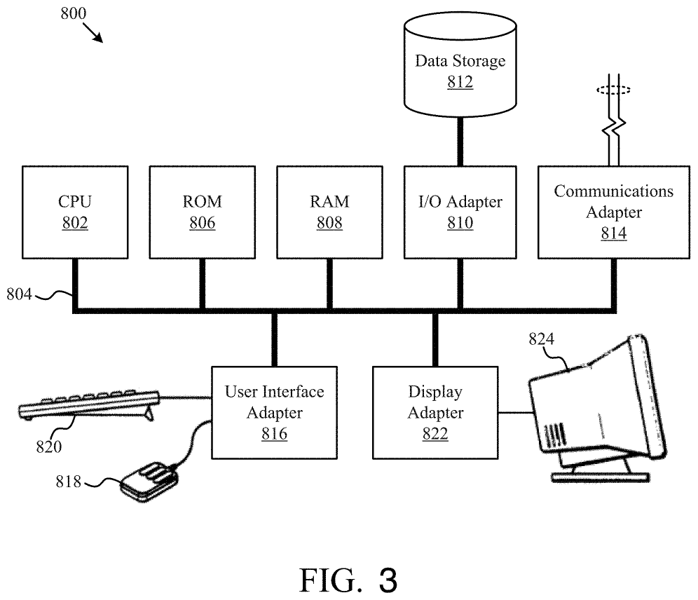

FIG. 2A provides a view of an exemplary electronic flashcard 200 wherein pressing a first button 204 may cause the individual letters 206, 208, 210, 212 of the subject sight word to light in sequence. As depicted, the letter “k” 210 is lit. In some embodiments, this may be accompanied with an audible recitation of the letters as they light.

As depicted in FIG. 2A, in some embodiments the letters 206, 208, 210, 212 may be debossed from the surface of the electronic flashcard 200. This may provide a tactile experience that may be helpful to some learners and/or may allow for the learner to trace the subject word.

FIG. 2B illustrates a view of an exemplary electronic flashcard 250 wherein the pressing of a second button 254 may cause the audible pronunciation of the subject sight word. Additionally, in some embodiments, in coordination with the pronunciation of the subject sight word all of the letters 258 of the subject sight word may light in unison.

With continued reference to FIG. 2B, pressing a third button 262 may cause a song to play relating to the subject sight word. Pressing a fourth button 266 may activate an audio recording function to enable the student to record herself reciting the subject sight word. In some embodiments, pressing and holding the fourth button 266 may initiate recording of the students voice, whereas tapping the fourth button 266 may initiate playback of the recording.

Embodiments of the present invention may be implemented as a computer system. FIG. 2 illustrates a computer system 800 adapted according to certain embodiments of the present invention. The central processing unit (“CPU”) 802 is coupled to the system bus 804. The CPU 802 may be a general purpose CPU or microprocessor, graphics processing unit (“GPU”), and/or microcontroller. The present embodiments are not restricted by the architecture of the CPU 802 so long as the CPU 802, whether directly or indirectly, supports the operations as described herein. The CPU 802 may execute the various logical instructions according to the present embodiments.

The computer system 800 also may include random access memory (RAM) 808, which may be synchronous RAM (SRAM), dynamic RAM (DRAM), synchronous dynamic RAM (SDRAM), or the like. The computer system 800 may utilize RAM 808 to store the various data structures used by a software application. The computer system 800 may also include read only memory (ROM) 806 which may be PROM, EPROM, EEPROM, optical storage, or the like. The ROM may store configuration information for booting the computer system 800. The RAM 808 and the ROM 806 hold user and system data, and both the RAM 808 and the ROM 806 may be randomly accessed.

The computer system 800 may also include an input/output (I/O) adapter 810, a communications adapter 814, a user interface adapter 816, and a display adapter 822. The I/O adapter 810 and/or the user interface adapter 816 may, in certain embodiments, enable a user to interact with the computer system 800. In a further embodiment, the display adapter 822 may display a graphical user interface (GUI) associated with a software or web-based application on a display device 824, such as a monitor or touch screen.

The I/O adapter 810 may couple one or more storage devices 812, such as one or more of a hard drive, a solid state storage device, a flash drive, a compact disc (CD) drive, a floppy disk drive, and a tape drive, to the computer system 800. According to one embodiment, the data storage 812 may be a separate server coupled to the computer system 800 through a network connection to the I/O adapter 810. The communications adapter 814 may be adapted to couple the computer system 800 to the network 708, which may be one or more of a LAN, WAN, and/or the Internet. The communications adapter 814 may also be adapted to couple the computer system 800 to other networks such as a global positioning system (GPS) or a Bluetooth network. The user interface adapter 816 couples user input devices, such as a keyboard 820, a pointing device 818, and/or a touch screen (not shown) to the computer system 800. The keyboard 820 may be an on-screen keyboard displayed on a touch panel. Additional devices (not shown) such as a camera, microphone, video camera, accelerometer, compass, and or gyroscope may be coupled to the user interface adapter 816. The display adapter 822 may be driven by the CPU 802 to control the display on the display device 824. Any of the devices 802-822 may be physical and/or logical.

The applications of the present disclosure are not limited to the architecture of computer system 800. Rather the computer system 800 is provided as an example of one type of computing device that may be adapted to perform the functions of a server 702 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 800 may be virtualized for access by multiple users and/or applications.

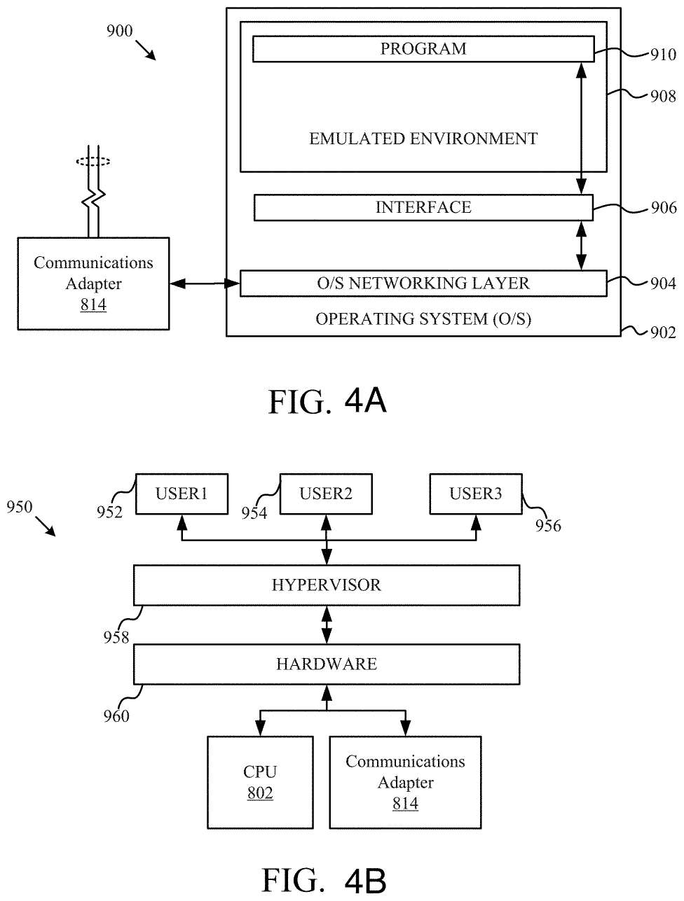

FIG. 4A is a block diagram illustrating a server hosting an emulated software environment for virtualization according to one embodiment of the disclosure. An operating system 902 executing on a server includes drivers for accessing hardware components, such as a networking layer 904 for accessing the communications adapter 814. The operating system 902 may be, for example, Linux. An emulated environment 908 in the operating system 902 executes a program 910, such as CPCommOS. The program 910 accesses the networking layer 904 of the operating system 902 through a non-emulated interface 906, such as XNIOP. The non-emulated interface 906 translates requests from the program 910 executing in the emulated environment 908 for the networking layer 904 of the operating system 902.

In another example, hardware in a computer system may be virtualized through a hypervisor. FIG. 4B is a block diagram illustrating a server hosting an emulated hardware environment according to one embodiment of the disclosure. Users 952, 954, 956 may access the hardware 960 through a hypervisor 958. The hypervisor 958 may be integrated with the hardware 960 to provide virtualization of the hardware 960 without an operating system, such as in the configuration illustrated in FIG. 9A. The hypervisor 958 may provide access to the hardware 960, including the CPU 802 and the communications adaptor 814.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. An electronic flashcard comprising:
a series of letters arranged to spell a subject sight word, wherein the series of letters are enabled to be individually lit;
a series of buttons enabled to induce a set of educational sensory experiences;
an audio output functionality, and
a memory.

2. The electronic flashcard of independent claim 1, wherein:
the series of buttons includes a first button, the first button enabled to induce the series of letters to light in sequence.

3. The electronic flash card of claim 2, wherein:
the first button is further enabled to induce an audible recitation of each letter in the series of letter through the audio output functionality as each letter is lit.

4. The electronic flashcard of independent claim 1, wherein:
the series of buttons includes a second button, the second button enabled to induce an audible recitation of the subject sight word through the audio output functionality.

5. The electronic flashcard of claim 4, wherein:
the second button is further enabled to induce the series of letters in unison to light as the subject sight word is audibly recited through the audio output functionality.

6. The electronic flashcard of independent claim 1, wherein:
the series of buttons includes a third button, the third button enabled to induce a song to be played through the audio output functionality.

7. The electronic flashcard of independent claim 1, wherein:
the series of buttons includes a fourth button, the fourth button enabled to induce a creation of an audio recording.

8. The electronic flashcard of claim 7, wherein:
the fourth button in further enabled to induce a playback of the audio recording.

9. The electronic flashcard of independent claim 1, wherein:
the audio output functionality is a speaker.

10. The electronic flashcard of independent claim 1, further comprising:
an audio input functionality;
wherein the series of buttons includes a fourth button, the fourth button enabled to initiate the audio recording functionality to record audio data received through the audio input functionality to the memory.

11. The electronic flashcard of claim 10, wherein:
the audio input functionality is a microphone.
